(19) United States
(12) Patent Application Publication
(10) Pub. No.: US 2012/0106827 A1
(43) Pub. Date: May 3, 2012

(54) WAFER INSPECTION METHOD

(75) Inventors: Heon Park, Seoul (KR); U-Lam Lee, Uijeongbu-si (KR); Cheong-Soo Kim, Suwon-si (KR); Jong-Man Kim, Hwaseong-si (KR)

(73) Assignee: SAMSUNG ELECTRONICS CO., LTD., Suwon-si (KR)

(21) Appl. No.: 13/186,970

(22) Filed: Jul. 20, 2011

(30) Foreign Application Priority Data
Nov. 1, 2010 (KR) 10-2010-0107559

(51) Int. Cl. G06K 9/00

(52) U.S. Cl. 382/149

(57) ABSTRACT

A wafer inspection method comprises: performing an exposure process on a wafer partitioned into fields, wherein the exposure process is performed on a first plurality of the fields in a first scan direction and wherein the exposure process is performed on a second plurality of the fields in a second scan direction; storing scan direction information for the first plurality of fields and the second plurality of fields corresponding to whether the exposure process is performed in the first scan direction or in the second scan direction; obtaining image information on the surface of the wafer subjected to the exposure process; determining whether a repetitive defect pattern is present in the image information; and determining whether the repetitive defect pattern is dependent on scan direction by identifying a correlation between the presence of repetitive defect patterns on the wafer and the scan direction information.

### RELATED APPLICATIONS

This application claims priority from Korean Patent Application No. 10-2010-0107559 filed on Nov. 1, 2010 in the Korean Intellectual Property Office, the disclosure of which is incorporated herein by reference in its entirety.

### BACKGROUND

1. Field

Embodiments relate to a wafer inspection method, and more particularly, to a method of inspecting a wafer for defects during a semiconductor manufacturing process.

2. Description of the Related Art

Semiconductor devices are generally formed by iteratively repeating a process of forming a plurality of films on a wafer and patterning the films. Specifically, a series of processes including photolithography, etching, thin-film deposition, and diffusion are repeatedly performed to form thin films having predetermined circuit patterns. Of these processes, the photolithography process is a process of printing a predesigned circuit pattern on a silicon wafer. The photolithography process largely consists of the placement of a photosensitive film coating, followed by exposure and development of that film coating. In the exposure process, a circuit pattern formed on a reticle is optically reduced and transferred accordingly onto a wafer coated with a photosensitive film. This is performed using an optical system comprising an optical path in turn including the reticle. The transfer is performed by an exposure device such as a scanner. Different types of exposure methods can be employed, including a batch exposure method, a partitioned exposure method, and a scan exposure method.

A small-mask exposure device performs an exposure process using the partitioned exposure method or the scan exposure method. In particular, the small-mask exposure device performs an exposure process using a number of smaller, relatively inexpensive, masks into which a conventional, relatively more expensive mask is partitioned, or divided. In this manner, the exposure process can be repeated using a plurality of repeated exposure steps using the small masks in a step & repeat method or in a scan method, thereby minimizing cost.

During device fabrication, various defects, including the presence of particles, the formation of voids, and the misalignment, or dislocation, of patterns, can occur. When the number of defects exceeds an allowable limit, the quality or reliability of a resulting semiconductor device can be adversely affected. Therefore, wafer inspection processes are performed to prevent or mitigate the occurrence of defects.

### SUMMARY

A wafer inspection method is provided by which a repetitive defect pattern on a wafer can be detected. In particular repetitive defect patterns that are dependent on scanning direction can be detected.

In one aspect, a wafer inspection method comprises: obtaining scan information comprising a scanning direction from an exposure device performing an exposure operation on a wafer; obtaining image information of a surface of the wafer subjected to the exposure operation; detecting positions of defects in the image information; determining whether the positions of the defects on the wafer correspond to a repetitive pattern; and determining whether the repetitive pattern is related to the scanning direction based on the scan information.

In some embodiments, the wafer inspection method further comprises extracting relation data indicating a relation between the repetitive pattern and the scanning direction.

In some embodiments, the relation data comprises defect occurrence time and defect rate.

In some embodiments, the wafer inspection method further comprises setting an interlock by analyzing the relation data.

In some embodiments, the wafer inspection method further comprises activating an alarm as a result of analyzing the relation data.

In some embodiments, the wafer is partitioned into fields, each field comprising a region corresponding to one or more dies of the wafer and wherein the scanning direction is a linear direction over each field.

In some embodiments, adjacent ones of the fields are scanned in opposite linear directions.

In some embodiments, the determining of whether the repetitive pattern is related to the scanning direction comprises: applying a sign indicating the scanning direction to each field of the wafer in the image information; and identifying the relation between the repetitive pattern and the scanning direction based on the sign applied to each field.

In some embodiments, the determining of whether the repetitive pattern is related to the scanning direction comprises: coding information about each field of the wafer in the image information; and coding information about the scanning direction.

In some embodiments, the wafer inspection method further comprises identifying the relation between the repetitive pattern and the scanning direction by comparing values of the coded information.

In another aspect, a wafer inspection method comprises: performing an exposure process on a wafer partitioned into fields, wherein the exposure process is performed on a first plurality of the fields in a first scan direction and wherein the exposure process is performed on a second plurality of the fields in a second scan direction; storing scan direction information for the first plurality of fields and the second plurality of fields corresponding to whether the exposure process is performed in the first scan direction or in the second scan direction; obtaining image information on the surface of the wafer subjected to the exposure process; determining whether a repetitive defect pattern is present in the image information; and determining whether the repetitive defect pattern is dependent on scan direction by identifying a correlation between the presence of repetitive defect patterns on the wafer and the scan direction information.

In some embodiments, the fields are arranged in rows on the wafer and wherein the exposure process is performed on adjacent fields of a row in alternating first and second scan directions.

In some embodiments, the second scan direction is opposite the first scan direction.

In some embodiments, determining whether a repetitive defect pattern is present in the image information comprises determining whether defect patterns appear in similar positions in multiple ones of the fields.

In some embodiments, the fields of the wafer each comprise regions corresponding to one or more dies of the wafer.

In some embodiments, performing the exposure process on a wafer partitioned into fields comprises performing the exposure process for each field of the wafer using the same reticle in the first scan direction and in the second scan direction.

In some embodiments, the scan direction information comprises a parameter representative of one of the first scan direction and the second scan direction that is assigned to each of the first plurality of fields and the second plurality of fields.

In some embodiments, determining whether the repetitive defect pattern is dependent on scan direction by identifying a correlation between the presence of repetitive defect patterns on the wafer and the scan direction information comprises monitoring and comparing a number of general repetitive defect patterns, a number of defect patterns that occur in the first plurality of fields, and a number of defect patterns that occur in the second plurality of fields.

In some embodiments, a determination is made that the repetitive defect pattern is dependent on scan direction when the number of defect patterns that occur in the first plurality of fields and the second plurality of fields is different.

In some embodiments, the wafer inspection method further comprises analyzing the occurrence of repetitive defect patterns dependent on scan direction over a time period.

### BRIEF DESCRIPTION OF THE DRAWINGS

The accompanying drawings are included to provide a further understanding of the inventive concept, and are incorporated in, and constitute a part of, this specification. The drawings illustrate exemplary embodiments of the inventive concept and, together with the description, serve to explain principles of the inventive concept. In the drawings:

FIG. 1 is a plan view illustrating the structure of a wafer;

FIG. 2 is a plan view of a wafer having defects on a surface thereof;

FIG. 3 is a plan view of a repetitive defect pattern extracted from the defects shown in FIG. 2;

FIG. 4 is a schematic diagram illustrating an exposure process performed according to a wafer scan method;

FIG. 5 is a diagram illustrating the scanning direction and scanning order of an exposure process performed sequentially over a wafer using the wafer scan method of FIG. 4;

FIG. 6 is a plan view of a wafer having scanning direction-dependent defects on a surface thereof;

FIG. 7 is a flowchart illustrating a wafer inspection method according to an embodiment of the present inventive concepts;

FIG. 8 is a diagram illustrating the operation of overlapping a sign indicating a scanning direction on each field of a wafer and identifying the presence of scanning direction-dependent defects based on the sign overlapped on each field in the wafer inspection method of FIG. 7;

FIG. 9 is a graph of the number of scanning direction-dependent defects, in accordance with the wafer inspection method of FIG. 7; and

FIG. 10 is a graph of characteristics of occurrence of scanning direction-dependent defects, in accordance with the wafer inspection method of FIG. 7.

### DETAILED DESCRIPTION OF EMBODIMENTS

Embodiments of the present inventive concept will now be described more fully hereinafter with reference to the accompanying drawings, in which preferred embodiments of the inventive concepts are shown. This invention may, however, be embodied in different forms and should not be construed as limited to the embodiments set forth herein. Like numbers refer to like elements throughout the specification.

It will be understood that, although the terms “first”, “second”, etc. are used herein to describe various elements, these elements should not be limited by these terms. These terms are used to distinguish one element from another. For example, a “first” element could be termed a “second” element, and, similarly, a “second” element could be termed a “first” element, without departing from the scope of the present inventive concepts. As used herein, the teem “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). When an element is referred to herein as being “over” another element, it can be over or under the other element, and either directly coupled to the other element, or intervening elements may be present, or the elements may be spaced apart by a void or gap.

The terminology used herein is for the purpose of describing particular embodiments and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

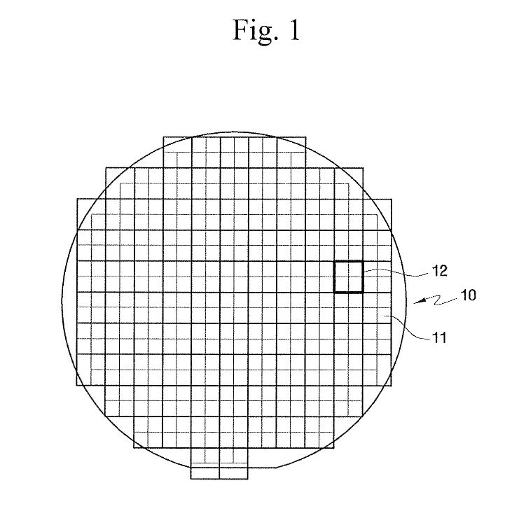

FIG. 1 is a plan view illustrating the structure of a wafer. Referring to FIG. 1, a predetermined pattern is formed on a wafer 10, and a plurality of chips or dies 11, are formed on the wafer 10. In one example, a chip or die comprises a unit that can be operated independently of other units. In an exposure process, a plurality of dies 11 are in turn grouped into a plurality of fields 12, where the fields are units of repetition. The fields 12 each correspond to a region of the wafer that is exposed under an exposure process using a reticle. The entire wafer 10 is partitioned into a plurality of fields and the wafer is scanned using the reticle on a field-by field basis. Each field 12 typically consists of two to eight dies 11. Using the reticle having a similar arrangement of multiple die patterns, two to eight dies 11 can be formed on a surface of the wafer 10 in the same exposure process. In this manner, a field 12, as used herein for purposes of the present disclosure, can refer to a group of die patterns formed on the reticle and also to a group of dies formed on the wafer 10 using the reticle.

During device fabrication, various defects, including the presence of particles, the formation of voids, and the misalignment, or dislocation, of patterns can occur. In particular, a repetitive defect pattern may sometimes be detected by inspection equipment during a semiconductor manufacturing process. Such a repetitive defect pattern may sometimes result from repeated use of a defective reticle in a photolithography process, or may result from an exposure process performed using a scan method.

In either case, it is best for a repetitive defect pattern to be discovered early and corrected. Otherwise, such a repetitive defect may significantly reduce the resulting yield of successively produced wafers or chips, leading to a sharp increase in production cost.

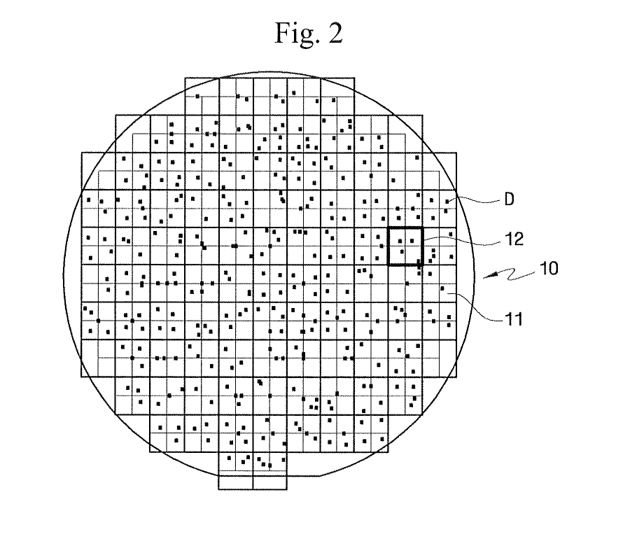

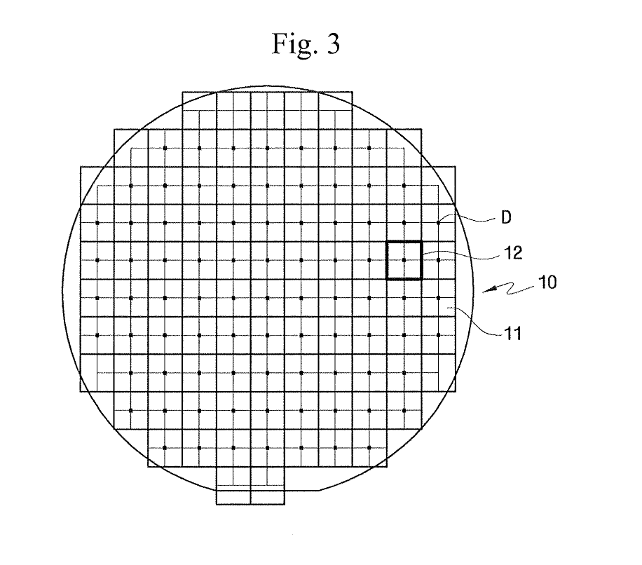

A wafer inspection method according to an exemplary embodiment of the present disclosure will now be described with reference to the attached drawings. FIG. 2 is a plan view of a wafer having defects on a surface thereof. FIG. 3 is a plan view of a repetitive defect pattern extracted from the defects shown in FIG. 2.

As described above, a repetitive defect pattern may sometimes be detected by inspection equipment during a semiconductor process. Referring to FIG. 2, defects D may be present on the entire surface of a wafer 10. In such a case, it needs to be determined whether the defects D are repetitive defects that have a certain pattern. In order to determine whether the defects D are indeed repetitive defects, the respective positions of the various defects D may be compared on a field-by-field basis. When the comparison result indicates that a defect D is repeatedly formed at the same position in each field 12, or in a high percentage of the fields 12, as shown in FIG. 3, it can be determined that the fields 12 have the same defect D at the same position. Accordingly, it can be identified that the defects D, and, in particular, the repetitive defect pattern, have resulted from exposure using a defective reticle. The defects D resulting from the defective reticle can be processed immediately after detection in order to prevent additional defects.

In some embodiments, a determination that the defects D have resulted from a defective reticle includes obtaining image information of the wafer 10, repeatedly comparing the image information on a field-by-field basis, and determining that the defects D are repetitive defects when all of the fields 12 have the defects D at the same positions.

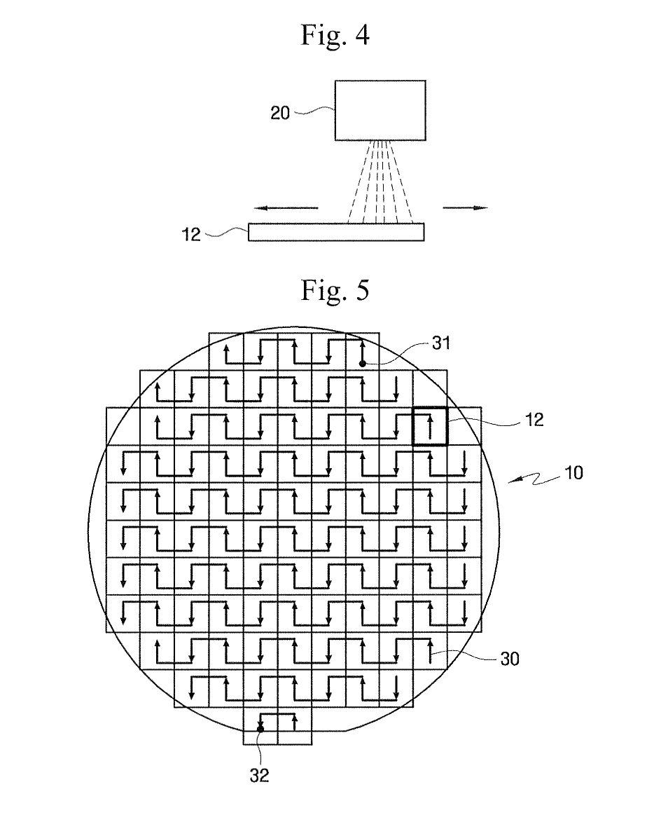

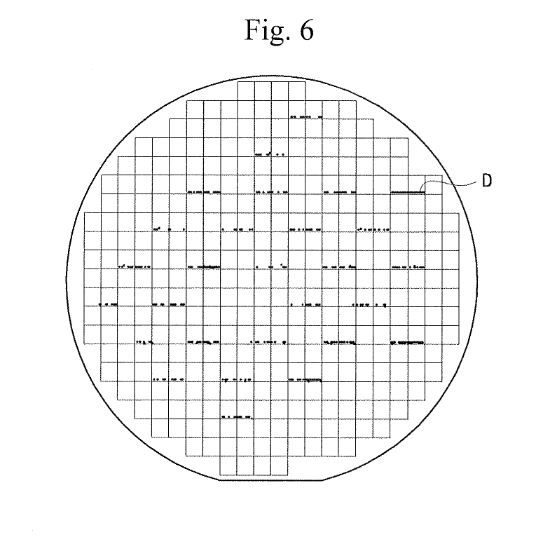

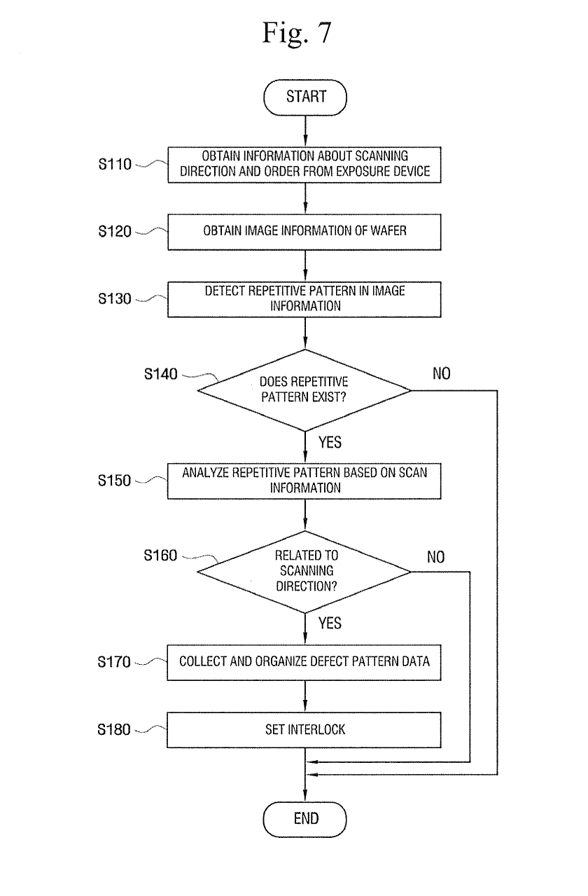

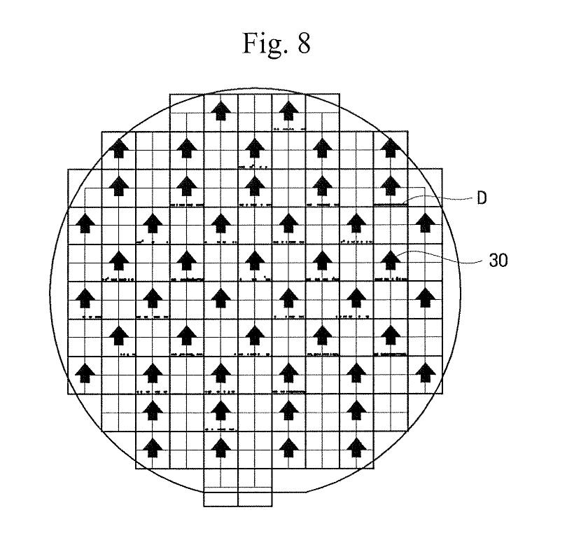

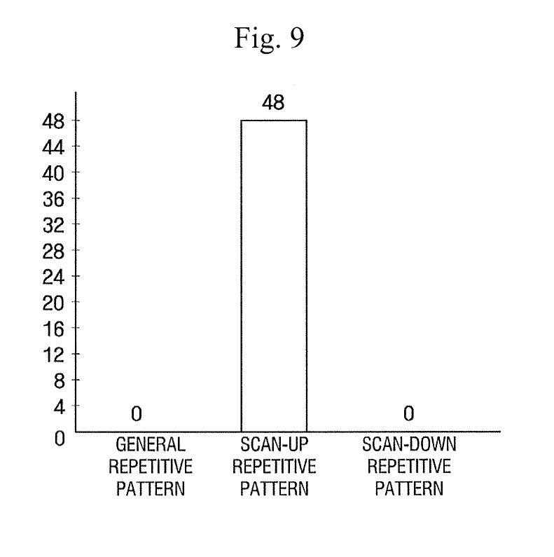

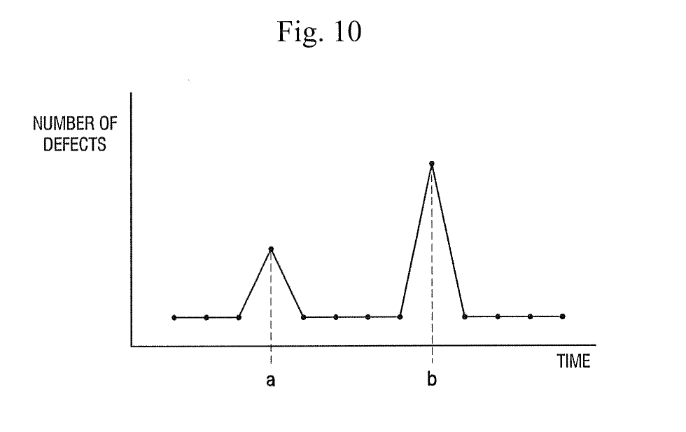

Repetitive defects formed according to a scanning direction during an exposure process and a method of identifying the repetitive defects according to an embodiment of the present inventive concepts will now be described with reference to FIGS. 4 through 10. FIG. 4 is a schematic diagram illustrating an exposure process performed using a wafer scan method. FIG. 5 is a diagram illustrating the scanning direction and scanning order of an exposure process performed sequentially over a wafer using the wafer scan method of FIG. 4. FIG. 6 is a plan view of a wafer having scanning direction-dependent defects on a surface thereof. FIG. 7 is a flowchart illustrating a wafer inspection method according to an exemplary embodiment of the present inventive concepts. FIG. 8 is a diagram illustrating the operation of overlapping a sign indicating a scanning direction on each field of a wafer and identifying the presence of scanning direction-dependent defects based on the sign overlapped on each field in the wafer inspection method of FIG. 7. FIG. 9 is a graph of the number of scanning direction-dependent defects, which is created in the illustrative wafer inspection method of FIG. 7. FIG. 10 is a graph of characteristics of occurrence of scanning direction-dependent defects, which is created in the wafer inspection method of FIG. 7.

As described above, repetitive defects resulting from a defective reticle can be readily identified by comparing the defects that repeat between fields 12. However, it is relatively more difficult to identify repetitive defects that correspond to a scanning direction during an exposure process. During a wafer exposure process, the entire wafer 10 is sequentially irradiated, or scanned, with ultraviolet rays using a reticle as a mask. As described above, the reticle corresponds to a field of the wafer that is to be exposed, each field in turn corresponding to a plurality of dies at which patterns are to be formed. Here, referring to FIG. 4, the wafer 10 is repetitively and continuously scanned on a field-by-field basis in a linear reciprocating manner. That is, a field 12 of the wafer is scanned by the exposure device 20 in a left-to-right direction in FIG. 4, for example, corresponding to a top-to-bottom direction in FIG. 5. A neighboring or adjacent field 12 of the wafer is scanned in a right-to-left direction in FIG. 4, for example, corresponding to a bottom-to-top direction in FIG. 5. This is referred to as a scanning exposure method. As described herein, in order to expose the entire wafer 10 at the same time using a single reticle, the exposure device 20 would require a large reticle. However, the use of such a large reticle may significantly increase production cost and decrease precision. For this reason, a scanning exposure method can be employed to scan the wafer 10 on a field-by-field basis, using a smaller reticle that is repeatedly used, thereby reducing the cost of the reticle.

Examples of the scanning direction of each field 12 of the wafer 10 and the scanning order of the fields 12 are illustrated in FIG. 5. In this example, the fields 12 of the wafer 10 are successively scanned from a first field 31 to a last field 32. The scanning direction and the scanning order are represented by scan information 30 in the form of a scan path. In the example of FIG. 5, a top row of fields of the wafer 10 are scanned from the rightmost field 31. After the scanning of the top of fields is completed, a next row of fields are scanned from the rightmost field to the leftmost field, or from the leftmost field to the rightmost field. Then, the next row of fields is scanned. In this way, the entire surface of the wafer 10 is scanned in a zig-zag manner from the top row of fields to the bottom row of fields. Here, in this example embodiment, each field 12 may be individually scanned in a top-to-bottom direction, or in a bottom-to-top direction, as shown in FIG. 5. In this manner, the fields 12 of the wafer can be divided into first fields that have undergone a scanning exposure operation in a first direction, for example a top-to-bottom direction, and into second fields that have undergone a scanning exposure operation in a second direction, for example a bottom-to-top direction. In some embodiments, the first fields that are scanned in the top-to-bottom direction can be referred to as scan-down type fields, and the second fields that are scanned in the bottom-to-top direction can be referred to as scan-up type fields. In this example embodiment, although the terms “top” and “bottom” are used to describe direction, other terms that identify opposed positions of a field are equally applicable, including “right” and “left”, “upper” and “lower”. The terms “top” and “bottom” are inclusive of these, and other, terms for describing opposed positions of a field.

Referring to FIG. 6, repetitive defects among the fields can result from the orientation of the scanning operation of the exposure process. For example, it can be identified that only the scan-down type fields 12 have defects at the same positions. Alternatively, it can be identified that only the scan-up type fields 12 have defects at the same positions. When defects D are formed on the wafer 10 as shown in FIG. 6, in the event that information related to scanning direction is not available, it is highly likely that those defects D will not be determined to be repetitive defects, since those defects D do not appear in all fields 12 of the wafer 10. That is, although adjacent fields 12 of the same row of fields of the wafer have been scanned in an upward and downward direction regularly and repeatedly, since the number of fields arranged in each row of the wafer 10 is not the same, it is not easy to determine a pattern in all defects D of the wafer 10 following the exposure process. However, the defects D shown in FIG. 6 are not random defects without a pattern, but instead are defects that are formed only in the scan-down type fields 12. Therefore, the defects D are indeed repetitive defects.

To address this issue, in a wafer inspection method as described in FIG. 7 scan information is obtained from an exposure device, where the scan information includes the scanning direction, or the direction or orientation of the movement of the exposure device 20 relative to a given field 12 of the wafer 10, at the time of the scan of that field. Image information of a surface of a wafer is also obtained. The positions of defects in the image information is determined. It is also determined whether the positions of the defects on the wafer form a repetitive pattern. It is also determined whether the repetitive pattern is related to the scanning direction based on the scan information.

Also, as described in connection with FIG. 7, in a wafer inspection method, an exposure process is performed on a wafer partitioned into fields, wherein the exposure process is performed on a first plurality of the fields in a first scan direction and wherein the exposure process is performed on a second plurality of the fields in a second scan direction. Scan direction information is stored for the first plurality of fields and the second plurality of fields corresponding to whether the exposure process is performed in the first scan direction or in the second scan direction. Image information on the surface of the wafer subjected to the exposure process is obtained. It is determined whether a repetitive defect pattern is present in the image information; and it is determined whether the repetitive defect pattern is dependent on scan direction by identifying a correlation between the presence of repetitive defect patterns on the wafer and the scan direction information.

Specifically, scan information including a scanning direction of each field of a wafer and a scanning order of the fields is obtained from an exposure device (operation S110). The scan information is used to determine whether a field is a scan-up-type field or a scan-down-type field during an exposure process. The scan information can be received from the exposure device. The exposure device stores the scan information including the scanning direction and the scanning order so that during a scan operation, each field of the wafer is assigned a scan direction. Following the termination of the exposure process, the scan information is transmitted to an inspection device. In one embodiment, the wafer inspection device employs a wafer inspection process.

Next, image information of a top surface of the wafer is captured (operation S120). An image pickup and processing device determines whether patterns are formed on the entire surface of the wafer. The principles and processes of obtaining the image information of the wafer may employ a combination of various known technologies. After the image information of the wafer is captured, digital image processing is performed. In this manner, the image information can be rapidly and accurately processed using a digital device including a central processing unit (CPU).

Next, positions of defects on the wafer are identified based on the obtained image information and are analyzed to determine whether the positions of the defects form a repetitive pattern (operation S130). In some embodiments, the positions of the defects may be identified by comparing shapes present on the fields with shapes present on a reticle used to expose the fields, based on the obtained image information. Alternatively, in some embodiments, the positions of the defects may be identified using a field-to-field method in which fields in the obtained image information are compared with each other, and corresponding positions which have different shapes relative to each other between the fields can be recognized as defects. After the positions of the defects in all fields are identified, they may be represented on the obtained image information of the wafer to match the image information. An example of this is provided at FIG. 2. The positions of the defects in the fields are coded, or coordinates of the positions of the defects are determined to identify whether the all of the fields, a certain percentage of the fields, or a majority of the fields, have defects present at positions that are the same among the fields. In this manner, the presence of repetitive defects can be identified (operation S140).

For example, the distribution of defects D shown in FIG. 2 may be analyzed to extract a particular defect that is common to all fields 12 as shown in FIG. 3. Since this defect is repeatedly formed at the same position in each of the fields 12, it can be determined to have resulted from a reticle.

On the other hand, defects D shown in FIG. 6 are concentrated in lower parts of lower dies 11 in a plurality of fields 12. Even when no particular pattern is found in the defects D, if the defects D are formed at the same positions in all fields 12, they are processed as repetitive defects.

When it is determined that the repetitive defects exist, they are analyzed based on the obtained scan information to identify a pattern in the repetitive defects (operation S150). Then, it is judged and determined whether the repetitive defects are related to the scanning direction based on the scan information (operation S160).

The determining of whether the repetitive defects are related to the scanning direction based on the obtained scan information (operation S160) may include designating a sign indicating the scanning direction on each field, which is a repetition unit of scan exposure, of the wafer in the image information and identifying whether the repetitive defects are related to the scanning direction based on the sign designated for each field.

For the purpose of illustration, the scan information including the scanning direction designated to each field can be overlapped on the obtained image information, as shown in FIG. 8. It can be identified from the overlapped scan information of FIG. 8 that the defects D illustrated in FIG. 6 are not random defects but instead are repetitive defects that correlate with the scanning direction of the fields. That is, referring to FIG. 8, the scan information 30 indicating scan-up-type fields among the fields 12 of the wafer 10 can be seen to match the defects D present on the wafer 10.

In this manner, it is determined that the identified repetitive defects are related to the scanning direction, and relation data indicating the relation between the repetitive defects (i.e., the repetitive defect pattern) and the scanning direction can be extracted (operation S170). That is, referring to FIG. 9, relation data is created by numerically representing general repetitive defects, scan-up repetitive defects, and scan-down repetitive defects. The relation data may be represented on a graph that can be easily understood by a user. The relation data may include the time of defect occurrences and/or the defect rate.

A graph of the relation between the time of defect occurrence and the number of defects may be plotted as shown in FIG. 10, and a time pattern of defect occurrence can thus be analyzed. Based on the analysis result, it can be identified at what intervals and under what conditions scanning direction-dependent repetitive defects occur, and measures to process the repetitive defects can be taken. For example, in FIG. 10, the number of defects significantly increases at times “a” and “b.” Therefore, conditions under which a process is performed at the times “a” and “b” may be analyzed to identify the cause of the repetitive defects.

Alternatively, the determination of whether the repetitive defects (i.e., the repetitive defect pattern) are related to the scanning direction based on the scan information (operation S160) may include coding information about each field. In this case, the coding information can be a repetition unit of scan exposure of the wafer shown in the image information and information about the scanning direction of each field. A relationship between the repetitive defects and the scanning direction can thus be identified by comparing values of the coded information. That is, information related to the number of defects on the fields and the distribution of the positions of the defects is coded or numerically represented as described above, so that the information can be quickly analyzed by a digital analyzer having a CPU. In addition, the scanning direction of each field, that is, information about whether each field is a scan-up type field or a scan-down type field can be coded or numerically represented. In this manner, values of the coded or numerically represented information are compared to rapidly identify the relationship between the repetitive defects and the scanning direction.

The above series of processes for identifying the presence of the scanning direction-dependent defects may be implemented in the form of a module in a conventional wafer inspection apparatus and provided as an extended function. That is, a menu on a client program of the conventional wafer inspection apparatus may be extended to additionally display the scanning direction on a display device, thereby allowing a program user to easily identify the presence of the scanning direction-dependent repetitive defects.

Next, the setting of an interlock by analyzing the relation data (operation S180) may further be performed. When the scanning-direction-dependent repetitive defects occur, a series of wafer procedures may be immediately stopped, and measures may be taken to process the scanning direction-dependent defects. Alternatively, the series of wafer processes may be stopped only when the scanning-direction-dependent repetitive defects occur under particular conditions.

An alarm can be activated when an analysis of the relation data is performed and results in a threshold value. For example, when repetitive defects occur without a user's knowledge, the alarm may be raised using an apparatus for generating sound or light, so that the user becomes aware of the presence of repetitive defects. In particular, an alarm may be raised that indicates to a user the presence of repetitive defects that are correlated to direction of the exposure scan of fields of the wafer.

While the inventive concepts have been particularly shown and described with reference to exemplary embodiments thereof, it will be understood by those of ordinary skill in the art that various changes in form and details may be made therein without departing from the spirit and scope of the inventive concepts as defined by the following claims. Therefore, the disclosed subject matter is to be considered illustrative and not restrictive.

What is claimed is:

1. A wafer inspection method comprising:
obtaining scan information comprising a scanning direction from an exposure device performing an exposure operation on a wafer;
obtaining image information of a surface of the wafer subjected to the exposure operation;
detecting positions of defects in the image information;
determining whether the positions of the defects on the wafer correspond to a repetitive pattern; and
determining whether the repetitive pattern is related to the scanning direction based on the scan information.

2. The method of claim 1, further comprising extracting relation data indicating a relation between the repetitive pattern and the scanning direction.

3. The method of claim 2, wherein the relation data comprises defect occurrence time and defect rate.

4. The method of claim 2, further comprising setting an interlock by analyzing the relation data.

5. The method of claim 2, further comprising activating an alarm as a result of analyzing the relation data.

6. The method of claim 1, wherein the wafer is partitioned into fields, each field comprising a region corresponding to one or more dies of the wafer and wherein the scanning direction is a linear direction over each field.

7. The method of claim 6, wherein adjacent ones of the fields are scanned in opposite linear directions.

8. The method of claim 6, wherein the determining of whether the repetitive pattern is related to the scanning direction comprises:
applying a sign indicating the scanning direction to each field of the wafer in the image information; and
identifying the relation between the repetitive pattern and the scanning direction based on the sign applied to each field.

9. The method of claim 6, wherein the determining of whether the repetitive pattern is related to the scanning direction comprises:
coding information about each field of the wafer in the image information; and
coding information about the scanning direction.

10. The method of claim 9, further comprising identifying the relation between the repetitive pattern and the scanning direction by comparing values of the coded information.

11. A wafer inspection method comprising:
performing an exposure process on a wafer partitioned into fields, wherein the exposure process is performed on a first plurality of the fields in a first scan direction and wherein the exposure process is performed on a second plurality of the fields in a second scan direction;
storing scan direction information for the first plurality of fields and the second plurality of fields corresponding to whether the exposure process is performed in the first scan direction or in the second scan direction;
obtaining image information on the surface of the wafer subjected to the exposure process;
determining whether a repetitive defect pattern is present in the image information; and
determining whether the repetitive defect pattern is dependent on scan direction by identifying a correlation between the presence of repetitive defect patterns on the wafer and the scan direction information.

12. The wafer inspection method of claim 11 wherein the fields are arranged in rows on the wafer and wherein the exposure process is performed on adjacent fields of a row in alternating first and second scan directions.

13. The wafer inspection method of claim 11 wherein the second scan direction is opposite the first scan direction.

14. The wafer inspection method of claim 11 wherein determining whether a repetitive defect pattern is present in the image information comprises determining whether defect patterns appear in similar positions in multiple ones of the fields.

15. The wafer inspection method of claim 11 wherein the fields of the wafer each comprise regions corresponding to one or more dies of the wafer.

16. The wafer inspection method of claim 11 wherein performing the exposure process on a wafer partitioned into fields comprises performing the exposure process for each field of the wafer using the same reticle in the first scan direction and in the second scan direction.

17. The wafer inspection method of claim 11 wherein the scan direction information comprises a parameter representative of one of the first scan direction and the second scan direction that is assigned to each of the first plurality of fields and the second plurality of fields.

18. The wafer inspection method of claim 11 wherein determining whether the repetitive defect pattern is dependent on scan direction by identifying a correlation between the presence of repetitive defect patterns on the wafer and the scan direction information comprises monitoring and comparing a number of general repetitive defect patterns, a number of defect patterns that occur in the first plurality of fields, and a number of defect patterns that occur in the second plurality of fields.

19. The wafer inspection method of claim 18 wherein a determination is made that the repetitive defect pattern is dependent on scan direction when the number of defect patterns that occur in the first plurality of fields and the second plurality of fields is different.

20. The wafer inspection method of claim 11 further comprising analyzing the occurrence of repetitive defect patterns dependent on scan direction over a time period.
